(19) United States
(12) Patent Application Publication
(10) Pub. No.: US 2006/0003148 A1
(43) Pub. Date: Jan. 5, 2006

(54) Interlocking polymeric foam floor underlayment and process for making

(76) Inventors: James L. Zwynenburg, Queensbury, NY (US); Gary R. Wilkes, Saratoga Springs, NY (US)

Correspondence Address: GARY RICHARD WILKES, 41 KNOLLWOOD DR., SARATOGA SPRINGS, NY, 12866, US

(21) Appl. No.: 10/880,866

(22) Filed: Jun. 30, 2004

(51) Int. Cl. B32B 3/26

(52) U.S. Cl. 428/157; 428/156; 428/158

(57) ABSTRACT

A polymeric foam structure for use as a supporting pad for floor surface layers made from laminated flooring, carpet, tile, or other functional materials. The polymeric foam structure comprises a continuous band having increased density and consistent width along each side of the polymeric foam structure. The bands may have a flat surface or they may be optionally equipped with a plurality of peaks and valleys continuing along the band in an alternating grid pattern. The bands may be oriented so that the thickness step occurs from the same surface or that the thickness step occurs on opposite surfaces. The bands of increased foam density on the polymeric foam structure may be produced by a batch thermoforming process or continuous process comprising an apparatus having heated cylindrical rollers.

### BACKGROUND OF THE INVENTION

The present invention is directed to a polymeric foam structure suitable for installation on floors as a supporting pad for the floor surface layer made from laminate flooring, carpet, tile, or other functional material.

Modern floors for commercial and residential buildings generally comprise three layers. The lower layer is typically a permanent sub-floor with a raw, unfinished surface. This sub-floor may be made of concrete, wood, or other solid material. The center layer is typically a padding material called an “underlayment”. Underlayment in common use has been composed of a variety of flexible, resilient materials, such as cork, polymeric foams, felt, and rubber. The top flooring layer typically has a decorative finished exterior surface. The top layer may be laminate flooring, carpet, asphalt tiles, linoleum, or other solid materials. Depending upon the needs and desires of the trustee of the building, the underlayment and the decorative upper layer may be changed many times over the useful life of the building. Thus, it is desirable that the underlayment be readily removed and easily installed.

The primary function of floor underlayment is to maximize the useful life of the decorative surface layer by absorbing shock in order to minimize wear. Additionally, the underlayment may serve to avoid impressing the unattractive surface pattern of a raw, unfinished sub-floor upon the top decorative floor surface.

Floor underlayment has generally been supplied in roll form or in sheets of a particular length, dependent upon the underlayment manufacturer. Although there have been recent reports of additions of attached films to some underlayment structures made from polymeric foam, the shape of essentially all floor underlayment can be described as basically a rectangular parallelepiped.

Floor underlayment is utilized in commercial and residential applications. In commercial applications, professional installers that have installation experience generally install floor underlayment. In residential applications, installers of floor underlayment may not have such prior experience. For both cases, ease of installation of the floor underlayment is a contributing factor to the cost and quality of the completed floor installation.

A disadvantage of the simple rectangular parallelepiped floor underlayment structure is that its installation requires very precise positioning to avoid gaps between or overlaps of adjacent pieces of the underlayment. Precise positioning of the floor underlayment increases the installation time and the overall cost of the floor. Even small misalignment of the floor underlayment can produce unattractive seams, depressions, or bulges on the decorative flooring upper layer. Also, several manufacturers of decorative upper layer flooring materials state in the warranty the installation conditions and materials. When gaps in the underlayment are present, many warranties are null and void.

### BRIEF SUMMARY OF THE INVENTION

It is an object of the present invention to produce a polymeric foam structure that is light in weight and easy to handle.

It is another object of the present invention to produce a polymeric foam structure that has a useful life of many years.

It is further object of the present invention to produce a polymeric foam structure with conventional foaming machinery.

Lastly, it is an object of the invention to produce a resilient, non-brittle, low cost polymeric foam structure that is easy to install in the flooring application as underlayment.

The polymeric foam structure of the present invention comprises two continuous bands of increased density and consistent width with a band along each side of the polymeric foam structure. The density of the foam within each band of increased density is about 150% to 300% of the mean density of the foam between the bands. The bands may have a flat surface or they may be optionally equipped with a plurality of peaks and valleys continuing along the band in an alternating grid pattern. The bands may be oriented so that the thickness step occurs on only one surface or so that the thickness steps occur on the opposite surfaces.

The polymeric foam structure may be produced in a continuous or batch process. The two bands of increased foam density on each side of the polymeric foam structure may be imparted simultaneously or separately. Each band of increased foam density is produced by passing the desired width of the polymeric foam sheet through the foam density-increasing apparatus. The preferred foam density-increasing apparatus comprises two heated rollers equipped with annular rings. The heated rollers are maintained at a temperature that provides sufficient heat to produce the bands permanently on the polymeric foam structure. The heated surface of the annular rings may optionally be provided with a grid pattern comprising a plurality of alternating peaks and valleys. The gap between the rollers is set to be about 40% to 60% of the thickness of the sheet. Each roller set is positioned so that only the desired width of the increased density band of the polymeric foam structure is contacted by the heated roller surface. The resulting polymeric foam structure can be collected in roll form or sheets of a predetermined length.

### BRIEF DESCRIPTION OF THE SEVERAL VIEWS OF THE DRAWING

Other objects and advantages of the invention will become apparent upon reading the following detailed description and upon reference to the drawing.

FIG. 1 is a perspective view illustrating an embodiment of the present invention with interlocking bands on opposing faces of the underlayment structure.

FIG. 2 is a perspective view illustrating an embodiment of the present invention with interlocking bands on the same face of the underlayment structure.

FIG. 3 is a cross-sectional view illustrating a cylindrical roller apparatus that could be utilized to prepare the present invention having interlocking bands on the opposing faces of the underlayment structure.

### DETAILED DESCRIPTION OF THE INVENTION

In general usage the term “polymer” is accepted to mean naturally occurring or synthetic compounds consisting of large molecules made up of a linked series of many smaller identical molecules. These smaller molecules are referred to as monomers. The list of polymers in everyday use is extensive. Polymers in everyday use include polystyrene, such as in plastic beverage cups; polypropylene, such as in plastic utensils; polyethylene terephthalate, such as in carbonated beverage bottles; high density polyethylene, such as in plastic milk jugs; and linear low polyethylene, such as in plastic garbage bags.

As referred herein, the term “polymeric foam” refers to materials that are comprised of a uniform and consistent mixture of one or more solid polymers and a gaseous material wherein the two phases are arranged so that the solid phase continuously encapsulates small cells of the gas throughout the domain of the material.

As referred herein, the term “polymeric foam structure” refers to a physical object that is comprised of polymeric foam.

As referred herein, the term “underlayment” refers to a physical object that is designed to be placed upon a floor between a sub-floor lower layer and a decorative flooring upper layer.

As referred herein, the terms “bottom” and “top” of the polymeric foam structure refer to the relative vertical position of the surfaces when the structure is placed into service as a floor underlayment. The bottom surface of the underlayment contacts the sub-floor lower layer and the top surface supports the decorative flooring upper layer. The measurable dimension between the “bottom” and “top” surfaces is the thickness of the polymeric foam structure.

As referred herein, the term “side” of the polymeric foam structure refers to the surfaces that are positioned perpendicular to the floor and extend in the major, or length direction of the structure. The measurable dimension between the two side surfaces is the overall width of the polymeric foam structure.

As referred herein, the term “end” of the polymeric foam structure refers to the surfaces that are positioned perpendicular to the floor and extend in the minor, or width direction of the structure. The measurable dimension between the two end surfaces is the length of the polymeric foam structure.

As referred herein, the term “band” refers to smaller intermediate surfaces that are essentially parallel to and between the top and bottom surface layers.

The polymeric foam structure of the present invention comprises two continuous bands of increased density and consistent width with a band along each side of the polymeric foam structure. In general, the overall width of the polymeric foam structure of the present invention is between 0.2 m and 2.0 m. Preferably, the overall width of the polymeric foam structure is between 0.3 m and 1.5 m. Most preferably, the overall width of the polymeric foam structure is between 0.6 m and 1.3 m. In general, the thickness of the polymeric foam structure of the present invention is between 1.5 mm and 16 mm Preferably, the thickness of the polymeric foam structure is between 2.0 mm and 12 mm. Most preferably, the thickness of the polymeric foam structure is between 2.2 mm and 6.5 mm.

In general, the width of a band of increased foam density should be between 1.5% and 15% of the overall width of the polymeric foam structure. Preferably, the width of a band of increased foam density should be between 2.5% and 10% of the overall width of the polymeric foam structure. Most preferably, the width of a band of increased foam density should be between 4.5% and 6.5% of the overall width of the polymeric foam structure.

The most preferred embodiment consists of a base shape in which the continuous bands of increased density and consistent width are directed in opposing directions along the vertical thickness axis. An alternative preferred embodiment consists of a base shape in which the continuous bands of increased density and consistent width are directed in the same direction along the vertical thickness axis. The bands on the polymeric structure of either base shape may optionally be equipped with a pattern consisting of one-dimensional or two-dimensional arrangement of alternating peaks and valleys.

Preferred Base Shape

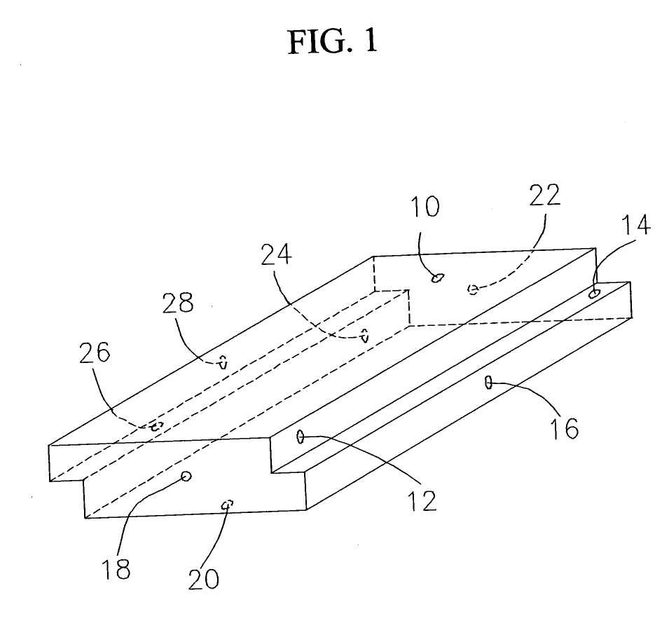

The illustration of FIG. 1 depicts a three-dimensional perspective view of the Preferred Base Shape of the polymeric foam structure. This illustration is a schematic and the dimensions of thickness, width, and length are not in relative scale. The solid lines depict the junctions of the polymeric foam structure surfaces that would be visible if the actual physical object were viewed from the perspective angle. The dashed lines depict the junctions of the polymeric foam structure surfaces that would not be visible if the actual physical object were viewed from the perspective angle.

Bottom Surface 20 of the polymeric foam structure will be placed in contact with the sub-floor lower layer. Top Surface 10 of the polymeric foam structure will be placed in contact with the decorative flooring upper layer. The vertical distance between Top Surface 10 and Bottom Surface 20 defines the thickness of the polymeric foam structure. The horizontal distance between Side Surface 16 and Side Surface 28 defines the width of the polymeric foam structure. The horizontal distance between End Surface 18 and End Surface 22 defines the length of the polymeric foam structure.

Surface 14 constitutes one band of the polymeric foam structure. For this Base Shape, Surface 14 is referred herein as the “Top-Facing Band”. Surface 12 is also formed in the process of making Surface 14. The horizontal distance between Surface 12 and Side Surface 16 is the width of the Top-Facing Band. The vertical distance between Top-Facing Band Surface 14 and Bottom Surface 20 is the thickness of the Top-Facing Band of the polymeric foam structure.

Surface 26 constitutes the second band of the polymeric foam structure. For this Base Shape, Surface 26 is referred herein as the “Bottom-Facing Band”. Surface 24 is also formed in the process of making Surface 26. The horizontal distance between Surface 24 and Side Surface 28 is the width of the Bottom-Facing Band. The vertical distance between Top Surface 10 and Bottom-Facing Band Surface 26 is the thickness of the Bottom-Facing Band of the polymeric foam structure.

The thickness of the Top-Facing Band in general should be within 33 to 67% of the thickness of the polymeric structure. Preferably, the thickness of the Top-Facing Band is within 45% and 55% of the thickness of the polymeric structure. Most preferably, the thickness of the Top-Facing Band is within 48% and 52% of the thickness of the polymeric structure. The sum of the thickness of the Bottom-Facing Band and the thickness of the Top-Facing Band in general should be within 90% to 110% of the thickness of the polymeric structure. Preferably, the sum of the thickness of the Bottom-Facing Band and the thickness of the Top-Facing Band is within 95% to 105% of the thickness of the polymeric structure. Most preferably, the sum of the thickness of the Bottom-Facing Band and the thickness of the Top-Facing Band is within 98% to 102% of the thickness of the polymeric structure.

The width of Bottom-Facing Band in general should be within 90% and 110% of the Top-Facing Band. Preferably, the width of Bottom-Facing Band is within 95% and 105% of the Top-Facing Band. Most preferably the width of Bottom-Facing Band is within 98% and 102% of the Top-Facing Band.

The mean density of the polymeric foam structure between Top Surface 10 and Bottom-Facing Band Surface 26 and the mean density of the polymeric foam structure between Bottom Surface 20 and Top-Facing Band Surface 14 will generally be about 150% to 300% of the mean density of the polymeric foam structure for the volume bounded by the extension of the planes of Surface 12 and Surface 24 and Top Surface 10 and Bottom Surface 20. Preferably, the mean density of the polymeric foam structure between Top Surface 10 and Bottom-Facing Band Surface 26 and the mean density of the polymeric foam structure between Bottom Surface 20 and Top-Facing Band Surface 14 is between 180% to 220% of the mean density of the polymeric foam structure for the volume bounded by the extension of the planes of Surface 12 and Surface 24 and Top Surface 10 and Bottom Surface 20. Most preferably, the mean density of the polymeric foam structure between Top Surface 10 and Bottom-Facing Band Surface 26 and the mean density of the polymeric foam structure between Bottom Surface 20 and Top-Facing Band Surface 14 is between 195% to 205% of the mean density of the polymeric foam structure for the volume bounded by the extension of the planes of Surface 12 and Surface 24 and Top Surface 10 and Bottom Surface 20.

Top-Facing Band Surface 14 and Bottom-Facing Band Surface 26 can be flat, or they can optionally be formed with an embossed pattern. The embossed pattern can be of any combination of useful shapes that is repeatable throughout the band and which allow Top-Facing Band Surface 14 and Bottom-Facing Band Surface 26 to mate together without interference.

Preferred embossed patterns consist of the following three-dimensional shapes: triangular grooves that extend in the width direction, triangular grooves that extend in the length direction, rectangular grooves that extend in the width direction, rectangular grooves that extend in the length direction, alternating pyramidal peaks and valleys wherein the height of the peaks is within 20% of the depth of the valleys, alternating conical peaks and valleys wherein the height of the peaks is within 20% of the depth of the valleys, and alternating frustoconical peaks and valleys wherein the height of the peaks is within 20% of the depth of the valleys.

The most preferred embossed patterns consist of triangular grooves that extend in the length direction and alternating frustoconical peaks and valleys wherein the height of the peaks is within 10% of the depth of the valleys.

In general, the vertical distance between the top of the peak of the embossed pattern and the bottom of the valley of the embossed pattern for the bands should not exceed 33% of the thickness of the polymeric foam structure. Preferably, the vertical distance between the top of the peak of the embossed pattern and the bottom of the valley of the embossed pattern for the bands should not exceed 25% of the thickness of the polymeric foam structure. Most preferably, the vertical distance between the top of the peak of the embossed pattern and the bottom of the valley of the embossed pattern for the bands should not exceed 15% of the thickness of the polymeric foam structure.

For installation as floor underlayment, the length of the polymeric foam structure is aligned with the length of the floor. Generally, the Bottom-Facing band at the edge of the floor would be removed from the structure for the first piece to start the installation. Then, the Top-Facing Band Surface 14 of the First Piece A of the polymeric foam structure is optionally coated with any useful adhesive. Next, the Bottom-Facing Band Surface 26 of a Second Piece B of the similar polymeric foam structure is forced into contact to interlock with the Top-Facing Band Surface 14 of First Piece A. Continuing the Bottom-Facing Band Surface 26 of a Third Piece B of the similar polymeric foam structure is forced into contact to interlock with the Top-Facing Band Surface 14 of Second Piece B. In a similar fashion, each additional piece is added across the width of the floor, as needed. The Bottom-Facing Band Surface of each successive piece of polymeric foam structure is placed upon the corresponding Top-Facing Band Surface of the preceding piece of polymeric foam structure. To end the installation, the final piece is cut to the width of the floor.

Alternate Base Shape

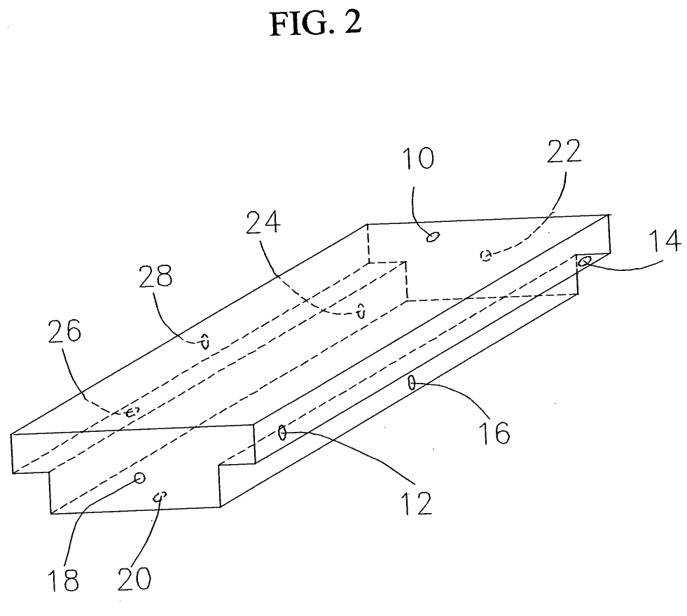

The illustration of FIG. 2 depicts a three-dimensional perspective view of an Alternate Base Shape of the polymeric foam structure. This illustration is a schematic and the dimensions of thickness, width, and length are not in relative scale. The solid lines depict the junctions of the polymeric foam structure surfaces that would be visible if the actual physical object were viewed from the perspective angle. The dashed lines depict the junctions of the polymeric foam structure surfaces that would not be visible if the actual physical object were viewed from the perspective angle.

In this Base Shape, Surface 20 and Surface 10 will alternate as top and bottom surfaces in actual usage as underlayment. For approximately one-half of the underlayment installation, Surface 20 of the polymeric foam structure will be placed in contact with the sub-floor lower layer and thus Surface 10 of the polymeric foam structure will be placed in contact with the decorative flooring upper layer. For the balance of the underlayment installation, Surface 10 of the polymeric foam structure will be placed in contact with the sub-floor lower layer and thus Surface 20 of the polymeric foam structure will be placed in contact with the decorative flooring upper layer. The vertical distance between Surface 10 and Surface 20 defines the thickness of the polymeric foam structure. The horizontal distance between Side Surface 12 and Side Surface 28 defines the width of the polymeric foam structure. The horizontal distance between End Surface 18 and End Surface 22 defines the length of the polymeric foam structure.

Surface 14 constitutes the first band of the polymeric foam structure for this Base Shape. Surface 12 is also formed in the process of making Surface 14. The horizontal distance between Side Surface 12 and Surface 16 is the width of the Surface 14.

Surface 26 constitutes the second band of the polymeric foam structure for this Base Shape. Surface 24 is also formed in the process of making Surface 26. The horizontal distance between Side Surface 24 and Surface 28 is the width of the Surface 26.

The width of Surface 26 in general should be within 90% and 110% of the Surface 14. Preferably, the width of Surface 26 is within 95% and 105% of the Surface 14. Most preferably the width of Surface 26 is within 98% and 102% of the Surface 14.

The mean density of the polymeric foam structure between Surface 10 and Band Surface 26 and the mean density of the polymeric foam structure between Surface 10 and Band Surface 14 will be generally be about 150% to 300% of the mean density of the polymeric foam structure for the volume bounded by the extension of the planes of Surface 16 and Surface 24 and Surface 10 and Surface 20. Preferably, the mean density of the polymeric foam structure between Surface 10 and Band Surface 26 and the mean density of the polymeric foam structure between Surface 10 and Band Surface 14 is within about 180% to 220% of the mean density of the polymeric foam structure for the volume bounded by the extension of the planes of Surface 16 and Surface 24 and Surface 10 and Surface 20. Most preferably, the mean density of the polymeric foam structure between Surface 10 and Band Surface 26 and the mean density of the polymeric foam structure between Surface 10 and Band Surface 14 is within about 195% to 205% of the mean density of the polymeric foam structure for the volume bounded by the extension of the planes of Surface 16 and Surface 24 and Surface 10 and Surface 20.

Surface 14 and Surface 26 can be flat, or they can optionally be formed with an embossed pattern. The embossed pattern can be of any combination of useful shapes that is repeatable throughout the band and which allow Surface 14 and Surface 26 to mate together without interference.

Preferred embossed patterns consist of triangular grooves that extend in the width direction, triangular grooves that extend in the length direction, rectangular grooves that extend in the width direction, rectangular grooves that extend in the length direction, alternating pyramidal peaks and valleys wherein the height of the peaks is within 20% of the depth of the valleys, alternating conical peaks and valleys wherein the height of the peaks is within 20% of the depth of the valleys, and alternating frustoconical peaks and valleys wherein the height of the peaks is within 20% of the depth of the valleys.

The most preferred embossed patterns consist of triangular grooves that extend in the length direction and alternating frustoconical peaks and valleys wherein the height of the peaks is within 10% of the depth of the valleys.

In general, the vertical distance between the top of the peak of the embossed pattern and the bottom of the valley of the embossed pattern for the bands should not exceed 33% of the thickness of the polymeric foam structure. Preferably, the vertical distance between the top of the peak of the embossed pattern and the bottom of the valley of the embossed pattern for the bands should not exceed 25% of the thickness of the polymeric foam structure. Most preferably, the vertical distance between the top of the peak of the embossed pattern and the bottom of the valley of the embossed pattern for the bands should not exceed 15% of the thickness of the polymeric foam structure.

For installation as floor underlayment, the length of the polymeric foam structure with the Alternate Base Shape is aligned with the length of the floor. First Piece A of polymeric foam structure is positioned so that its Surface 10 is in contact with the sub-floor lower layer. Generally, at the edge of the floor, Surface 26 and the volume of material associated with it would be removed from the structure of this piece to start the installation. Then, Surface 14 of the First Piece A of the polymeric foam structure is optionally coated with any useful adhesive. Next, Second Piece B of polymeric foam structure is positioned so that its Surface 20 is in contact with the subfloor lower layer. Surface 26 of a Second Piece B of the similar polymeric foam structure is forced into contact to interlock with Surface 14 of First Piece A. Continuing, Third Piece C is inverted in a manner to First Piece A so that its Surface 10 is in contact with the sub-floor lower layer. Surface 26 of Third Piece C of the similar polymeric foam structure is forced into contact to interlock with the Surface 14 of Second Piece B. In a similar fashion, additional pieces are added across the width of the floor, as needed, after placement of each Surface of each successive piece of polymeric foam structure on the corresponding surface of the preceding piece of polymeric foam structure. To end the installation, the final piece is cut to the width of the floor.

Polymeric Foam Structure Material Composition

The polymeric foam structure of the present invention can be composed of any useful polymeric foam material. In general, the particular polymeric foam chosen for the polymeric foam structure should have a Vertical Compression Set at 25% compression of less than 25%, as measured in accordance with ASTM D-3575. Although ASTM D-3575, entitled “Standard Test Methods for Flexible Cellular Materials Made from Olefin Polymers”, is specifically designed for polyolefins, such as low density polyethylene (LDPE) and polypropylene, application of the measurement procedures for this test produce reasonable results for certain polymeric foams that are not specifically polyolefins.

Suitable polymeric foams for the present invention will generally have a foam density between 10 and 300 kg/m³. Suitable polymer foams for material composition of the polymeric foam structure include, but are not limited to: polyurethane, polypropylene, low density polyethylene, two-polymer blend foams comprising low density polyethylene and an ethylene copolymer, two-polymer blend foams comprising polypropylene and a thermoplastic elastomer, two-polymer blend foams comprising high density polyethylene and polystyrene, three-polymer blend foams comprising high density polyethylene, polystyrene, and low density polyethylene, and three-polymer blend foams comprising high density polyethylene, polystyrene, and linear low density polyethylene.

Preferred polymeric foams for the present invention have a foam density between 20 and 100 kg/m³. Most preferred polymeric foams for the present invention have a foam density between 25 and 65 kg/m³.

Process of the Present Invention

The polymeric foam structure of the present invention can be made by a batch process, such as by thermoforming, or by a continuous process. Preferably, the polymeric foam structure is made in a continuous process.

According to one batch process for the present invention, sheet lengths of the polymeric foam sheet are placed in a thermoforming oven with localized heating elements and heated to the softening point of the polymeric foam sheet. The band and the desired embossed pattern are impressed upon the softened area by the platens of the thermoforming apparatus.

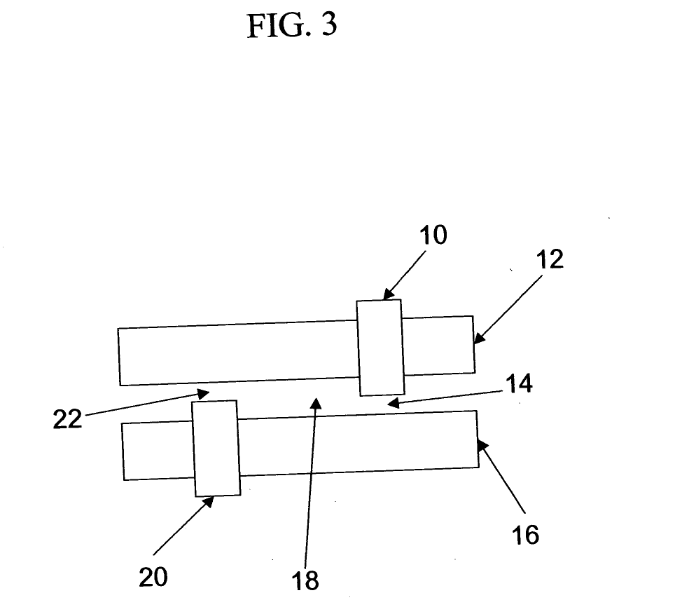

According to one continuous process of the present invention, polymeric foam sheet either from roll stock or from continuous foam sheet manufacturing equipment is drawn continuously through a rotating roller stand containing at least two heated cylindrical rolls. The heated cylindrical rolls are heated to a temperature that is sufficient to permanently deform the polymeric foam after the sheet comes in contact with the rolls. FIG. 3 depicts the cross sectional of one configuration for the heated roller apparatus that could be utilized to prepare the polymeric foam structure with the band surfaces in the opposing direction.

In FIG. 3, Top Cylindrical Roll 12 is equipped with Top Annular Ring 10. Top Annular Ring 10 is affixed with the inverse of the embossed pattern, if any, to be placed upon the Top-Facing Band. Bottom Cylindrical Roll 16 is equipped with Bottom Annular Ring 20. Bottom Annular Ring 20 is affixed with the inverse of the embossed pattern, if any, to be placed upon the Bottom-Facing Band. The horizontal distance between the Top Annular Ring 10 and Bottom Annular Ring 20 is configured to be the overall width of the polymeric foam structure diminished by the sum of the widths of the Top-Facing Band and Bottom Facing Band. The distance between the Cylindrical Roll 12 and Cylindrical Roll 16 is Roll Gap 18. The measurement of Roll Gap 18 is configured to be 105% to 110% of the thickness of the polymeric foam structure. The distance between the Top Annular Ring 10 and Bottom Cylindrical Roll 16 forms Top-Facing Band Gap 14. Top-Facing Band Gap 14 is configured to be 98% to 102% of the thickness of the Top-Facing Band of the polymeric foam structure. The distance between the Top Cylindrical Roll 12 and Bottom Annular Ring 20 forms Bottom-Facing Band Gap 22. Bottom-Facing Band Gap 22 is configured to be 98% to 102% of the thickness of the Bottom-Facing Band of the polymeric foam structure. In operation, polymeric foam sheet is aligned and continuously drawn through the rotating heated roller apparatus, so as to produce the polymeric foam structure with the desired dimensions.

One skilled in the art can determine that a heated roller apparatus could similarly be made to produce the polymeric foam structure having the Alternate Base Shape with the bands on the same surface. In this case Annular Ring 10 and Annular Ring 20 would be placed upon the same cylindrical roller.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A polymeric foam structure made from polymeric foam which has a foam density within the range of 10 kg/m³ and 300 kg/m³ and comprising two continuous longitudinal bands of increased density and consistent width that are located along each side of the sheet and that proceed along the length direction of the structure, wherein the bands are optionally affixed with an embossed pattern of alternating peaks and valleys.

2. The polymeric foam structure of claim 1 wherein the polymeric foam composition is selected from the group comprising: polyurethane, polypropylene, low density polyethylene, two-polymer blend foams comprising low density polyethylene and an ethylene copolymer, two-polymer blend foams comprising polypropylene and a thermoplastic elastomer, two-polymer blend foams comprising high density polyethylene and polystyrene, three-polymer blend foams comprising high density polyethylene, polystyrene, and low density polyethylene, three-polymer blend foams comprising high density polyethylene, polystyrene, and linear low density polyethylene.

3. The polymeric foam structure of claim 1 wherein the foam density of the polymeric foam is within the range of 20 to 100 kg/m³.

4. The polymeric foam structure of claim 3 wherein the foam density of the polymeric foam is within the range of 25 to 65 kg/m³.

5. The polymeric foam structure of claim 1 wherein the longitudinal bands are facing in opposing directions along the thickness axis.

6. The polymeric foam structure of claim 1 wherein the optional embossed pattern is selected from the group consisting of triangular grooves that extend in the width direction, triangular grooves that extend in the length direction, rectangular grooves that extend in the width direction, rectangular grooves that extend in the length direction, alternating pyramidal peaks and valleys wherein the height of the peaks is within 20% of the depth of the valleys, alternating conical peaks and valleys wherein the height of the peaks is within 20% of the depth of the valleys, and alternating frustoconical peaks and valleys wherein the height of the peaks is within 20% of the depth of the valleys.

7. The polymeric foam structure of claim 6 wherein the embossed pattern is selected from the group consisting of triangular grooves that extend in the width direction, triangular grooves that extend in the length direction, and alternating frustoconical peaks and valleys wherein the height of the peaks is within 10% of the depth of the valleys.

8. A batch or continuous process for converting polymeric foam sheet that has a foam density within the range of 10 kg/m³ and 300 kg/m³ into a polymeric foam structure comprising two continuous longitudinal bands of increased density and consistent width that are located along each side of the sheet and that proceed along the length direction of the structure, wherein the bands are optionally affixed with an embossed pattern of alternating peaks and valleys.

9. The process of claim 8 wherein the process is a continuous process and consists of drawing polymeric foam sheet continuously through an apparatus comprising at least two heated cylindrical rolls equipped with annular rings.

10. The process of claim 9 wherein one annular ring is located on each cylindrical and spaced to produced bands on the sides of the polymeric foam structure.

11. The process of claim 10 wherein both annular rings are provided with a surface that will impart an embossed pattern on the bands of the polymeric foam structure, wherein the bands are selected from the group consisting of triangular grooves that extend in the width direction, triangular grooves that extend in the length direction, rectangular grooves that extend in the width direction, rectangular grooves that extend in the length direction, alternating pyramidal peaks and valleys wherein the height of the peaks is within 20% of the depth of the valleys, alternating conical peaks and valleys wherein the height of the peaks is within 20% of the depth of the valleys, and alternating frustoconical peaks and valleys wherein the height of the peaks is within 20% of the depth of the valleys.

12. The process of claim 11 wherein both annular rings are provided with a surface that will impart an embossed pattern on the bands of the polymeric foam structure, wherein the bands are selected from the group consisting of triangular grooves that extend in the length direction, and alternating frustoconical peaks and valleys wherein the height of the peaks is within 10% of the depth of the valleys.
